(19) United States
(12) Patent Application Publication
(10) Pub. No.: US 2014/0265842 A1
(43) Pub. Date: Sep. 18, 2014

(54) Underwater Lighting System With Bather Detection Circuitry

(71) Applicant: Hayward Industries, Inc., Elizebeth, NJ (US)

(72) Inventors: Kevin L. Potucek, Far Hills, NJ (US); Stuart Baker, Westfield, NJ (US)

(73) Assignee: Hayward Industries, Inc., Elizebeth, NJ (US)

(21) Appl. No.: 14/205,936

(22) Filed: Mar. 12, 2014

Related U.S. Application Data
(63) Continuation-in-part of application No. 13/840,751, filed on Mar. 15, 2013.

(51) Int. Cl. H05B 37/02

(52) U.S. Cl. CPC H05B 37/02
USPC 315/77

(57) ABSTRACT

The present disclosure relates to a lighting fixture for use in connection with a swimming pool or spa. The lighting fixture includes a light source, and a detection device for detecting the presence of a bather in a pool or a spa. A microprocessor is in electrical communication with the detection device and the light source. The microprocessor adjusts an output of the light source when a bather is detected in the pool or the spa. The microprocessor could adjust the color of the light emitted by the light source when a bather is detected.

### CROSS-REFERENCE TO RELATED APPLICATIONS

This application is a continuation-in-part of U.S. Non-Provisional application Ser. No. 13/840,751 filed on Mar. 15, 2013, the entire disclosure of which is expressly incorporated herein by reference.

### FIELD OF THE DISCLOSURE

The present disclosure relates to underwater lighting systems, and more particularly to lighting systems with bather detection circuitry for use in swimming pools, spas and the like.

### RELATED ART

In-ground commercial and residential swimming pools and spas are often installed with lights, typically in a horizontal row a short distance below the waterline. These lights conventionally were standard white lights. More recently, color-changing lights have been used, with programmable controllers for turning selected lights on and off, effectively producing an underwater light show for the pool's bathers and bystanders/spectators. Adequate lighting in pools and spas is important for safety reasons for bathers. There is a generally a higher standard of pool/spa illumination for safe active bather use and a lesser standard for safe pool/spa illumination for bystanders/spectators.

In a typical application, an underwater light fixture (also called a luminaire) includes an array of light-emitting diodes (LEDs) coupled to a microprocessor. LEDs are available in various colors (e.g., red, green, blue, white, etc.). A specific color in a light fixture may be obtained by powering different LEDs in combinations of primary colors (e.g., LEDs in red, green and blue). The light fixture could be programmed to change colors at certain time intervals.

In certain jurisdictions, commercial and residential swimming pools and spas may have minimum illumination requirements for safe use. While color-changing LED lights have a pleasing visual effect, they may emit lumens in certain color modes that are below the minimum illumination requirements. As such, existing color LED pool and spa lights may not be suitable for use in certain applications because they do not meet applicable lighting codes. It is therefore desirable to provide a lighting system where the color-changing LED light may automatically change its output so that the light emits a sufficient amount of lumens when bathers are in a pool or spa.

### SUMMARY

In accordance with the present disclosure, a lighting fixture is provided for use in connection with a swimming pool or spa. In particular, the lighting fixture includes a light source, and a detection device for detecting the presence of a person within a pool or spa. The detection device transmits a signal into the pool/spa water, and receives a reflected signal from a bather in the pool or spa to detect the presence of the bather. A microprocessor is in electrical communication with the detection device and the light source. The microprocessor adjusts an output of the light source when the bather is detected, so that sufficient light output is generated by the underwater lighting fixture.

In accordance with another embodiment, a lighting system for use in connection with a swimming pool or spa is provided. The lighting system includes a lighting fixture with a light source, a microprocessor for controlling the light source, and a mechanism for detecting the presence of a person within a pool or a spa. The microprocessor changes the color of light emitted from the light source such that the light source emits white color when the bather is detected within the pool or spa.

In another embodiment, a method for controlling a lighting fixture in a swimming pool or spa is provided. The method includes the steps of illuminating a pool or spa with a lighting fixture, detecting the presence of a person in the pool or spa, and changing the color output of the lighting fixture to an acceptable lighting condition (e.g., white light output, white and/or color output at acceptable lumen level, etc.) when a person is detected in the pool or spa.

### BRIEF DESCRIPTION OF THE DRAWINGS

The foregoing features of the present disclosure will be apparent from the following Detailed Description, taken in connection with the accompanying drawings, in which:

FIG. 1 is a perspective view showing an underwater color-changing light fixture with bather detection circuitry in accordance with the present disclosure;

FIG. 2 is a block diagram of the light fixture of light fixture of FIG. 1;

FIG. 3 is a flowchart showing processing steps according to an embodiment of the present disclosure for detecting a bather in a pool or spa and controlling output of an underwater pool/spa light based on detection of a bather;

FIG. 4 schematically illustrates a lighting system constructed in accordance with the present disclosure for use in connection with a swimming pool; and

FIG. 5 schematically illustrates a lighting system constructed in accordance with an embodiment of the present disclosure for use in connection with a swimming pool.

### DETAILED DESCRIPTION

The present disclosure relates to an underwater color-changing light fixture having detection circuitry for detecting bathers in a swimming pool, spa, or the like. When the detection circuitry detects a bather, the light fixture automatically changes the color of the emitted light such that the light fixture emits a constant light having a fixed color, such as white light.

FIG. 1 is a perspective view showing an underwater color-changing light fixture 10 of the present disclosure. The light fixture 10 includes one or more light emitting diodes (LEDs) 12 as a light generator and is adapted to be submersed underwater for providing underwater illumination. The light fixture 10 could employ differently colored LEDs 12 (e.g., red LEDs, green LEDs, blue LEDs, and white LEDs) and could be adapted to generate a variety of different colors, including white. A specific color could be obtained by powering different LEDs in combinations of primary colors (e.g., LEDs in red, green, and blue). The use of LEDs is only exemplary. It will be understood that the light fixture 10 could include a light source that is not LED-based, and/or a light source that is a combination of LED-based and non LED-based.

The light fixture 10 could include a detection device 14 located in the body 16 of the light fixture 10, behind a central lens portion 18, or in a bezel 20 positioned about the central lens portion 18. Alternatively, the detection device 14 could be located remotely from the light fixture 10, such as in any location within the vicinity of a pool or spa, or in a niche or a recess in the pool or spa that contains the light fixture 10. The detection device 14 senses the presence of a person in a swimming pool or spa by conventional methods, such as by detecting the movement of water in the pool or spa, or by detecting infrared energy, ultrasonically, etc. The detection device 14 could be any type of sensor or detector, such as a passive and/or active sonar detector, an infrared sensor, a thermal sensor, a wave sensor, an acoustic sensor, a temperature sensor, a vibration sensor, a photosensor, a light sensor, a piezoelectric device, a transducer, or a motion detector. When the detection device 14 detects the presence of a person in a swimming pool, the light fixture 10 automatically changes or calibrates the color and/or intensity of the light such that the light fixture 10 emits a constant light having a fixed color, such as white light.

FIG. 2 is a block diagram of a light fixture 10 according to an embodiment of the present disclosure. The light fixture 10 includes several types of electrical components, such as the LEDs 12, transistors 22 for driving the LEDs 12, the detection device (sensor) 14, a receiver 24, a microprocessor 26, one or more memories 28, and a power supply 30. The memory 28 stores preset light programs and/or algorithms for controlling output of the fixture 10. The power supply 30 provides power to the microprocessor 26 and to the light fixture 10.

The microprocessor 26 controls the color of the light emitted from the LEDs 12, as disclosed in co-pending U.S. patent application Ser. No. 11/946,685, the entire disclosure of which is expressly incorporated herein by reference. In particular, the microprocessor 26 executes programs that could be a list of colors (i.e., a set of steps) to be played back in order and a time between the steps. The programs could include one or more color-changing light programs. When one of the color-changing light programs is executed, the light fixture 10 generates a lightshow by sequentially producing lights having predetermined colors, each color displayed for a certain period of time. For example, the light fixture 10 could sequentially generate a light having a red color, a light having a blue color, and a light having a white color, each color displayed for two seconds. Additionally, the programs could include one or more fixed light programs. When one of the fixed light programs is selected, the light fixture 10 generates a constant light having a fixed color. For example, the light fixture 10 could transmit a constant light having a blue color.

The microprocessor 26 is in communication with the detection device 14. In particular, the microprocessor 26 receives reflected signals that have been emitted from the detection device 14, processes the signal, and adjusts the color of the light emitted from the LEDs 12 when a bather has been detected. In one embodiment, the microprocessor 26 adjusts the color of light emitted from the LEDs 12 based on the signal received from the detection device 14 such that the light fixture 10 transmits a constant light having an acceptable lumen output (e.g., white light or color light). Optionally, a separate receiver 24 could be provided for receiving/detecting reflected signals from a bather.

The microprocessor 26 could adjust or calibrate parameters of the LEDs 12, other than color. For example, the microprocessor 26 could adjust the brightness of the light emitted from the LEDs 12 and/or other parameters of the LEDs 12 such that the light fixture 10 transmits a light having a brightness, intensity, and/or color sufficient to satisfy the minimum illumination requirements of applicable lighting codes. The microprocessor 26 could transmit a signal to LED transistors 22 that drive the LEDs 12.

In one embodiment, a signal from one light fixture could be transmitted over a network to the receiver of another light fixture. Any type of networking mechanisms (e.g., wired, wireless, optical communication) could be utilized for allowing communication between one or more stand-alone sensors and one or more light fixtures, between two or more light fixtures, and/or between one or more light fixtures and a central controller.

FIG. 3 is a flowchart showing processing steps according to an embodiment of the present disclosure, indicated generally at 32, for controlling lights in a pool or spa. In step 34, the color-changing light fixture 10 produces lights having predetermined colors, while, in step 36, the microprocessor 26 simultaneously monitors the detection device, such as the sensor 14. In step 38, a determination is made as to whether a bather is detected in a swimming pool or spa. This determination is accomplished with the use of the sensor 14 detecting a parameter associated with the presence of a bather. If a negative determination is made, control returns to step 36. Otherwise, if a positive determination is made in step 38, step 40 occurs, wherein the microprocessor 26 initiates a timer for a predetermined period of time. Then or concurrently with the initiation of the timer, the microprocessor 26 adjusts the color of the light emitted from the LEDs 12 based on the sensor 14 such that a fixed light program is executed in step 42. In the example shown in FIG. 3, the light fixture 10 transmits a constant light output having a white color. In step 44, a determination is made as to whether a timeout has occurred (e.g., whether the predetermined period of time has expired). If a negative determination is made, processing reverts to step 42. Otherwise, in step 46, another determination is made as to whether a bather is detected in a swimming pool or spa. This is accomplished using the sensor 14. If a negative determination is made, control returns to step 34, wherein the light fixture 10 emits lights having predetermined colors while the microprocessor 26 monitors the sensor 14. Otherwise, if a positive determination is made in step 46, control returns to step 40, wherein the microprocessor 26 initiates the timer for another predetermined period of time. The processing steps shown in FIG. 3 allow a light fixture 10 to automatically change to full lumen white light when bathers are in a pool or spa.

In one embodiment, the sensor 14 senses one or more parameters associated with the operation of the pool, spa, or light. These parameters could include, for example, lumen performance, lumen output, amount of lumen depreciation, lighting component temperature, water temperature, flow rates, chlorination levels, pH levels, etc. If the microprocessor 26 determines that the parameter falls outside of a predetermined range based on a signal from the sensor 14, the light fixture 10 could automatically transmit a constant light, such as a white color. The constant light could serve as an alarm to indicate that there is an issue with the pool, spa, or light.

FIG. 4 schematically illustrates a lighting system 48 constructed in accordance with the present disclosure for use in connection with a swimming pool 50. More particularly, the lighting system 48 includes light fixtures 10a, 10b mounted to side walls 52, 54, respectively, of the pool 50. The lighting system 48 could be equipped with a control system (not shown) which is connected to each of the light fixtures 10a, 10b for controlling the operation of the light fixtures 10a, 10b. One or more sensors 14 could be located in any desired location, such as in each of the light fixtures 10a, 10b. Alternatively or additionally, one or more sensors 14 could be located remotely from the light fixtures 10a, 10b, such as adjacent to the entrances of the pool 50. In the example shown in FIG. 4, sensors 14 are provided near a pool ladder 56, steps 58 that lead into the pool 50, and in each of the light fixtures 10a, 10b. A sensor 14 could be located outside of the pool 50. One or more sensors 14 could be in communication with one or more light fixtures 10a, 10b through a wired network or a wireless network. For example, a signal from the sensor 14 located adjacent to the pool ladder 56 could be received by a receiver 24 in the light fixture 10b. It will be understood that the number of light fixtures and the number of sensors could vary.

FIG. 5 schematically illustrates a lighting system 148 constructed in accordance with an embodiment of the present disclosure for use in connection with a swimming pool 150. More particularly, the lighting system 148 includes light fixtures 110a, 110b, 110c mounted to walls 152, 154, 156, respectively, of the pool 50. The lighting system 148 could be equipped with a control system 120 which is connected to each of the light fixtures 110a, 110b, 110c via power lines 122a, 122b, 122c, respectively, for controlling the operation of the light fixtures 110a, 110b, 110c. A sensor 114 could be located in any desired location, such as in the light fixture 110a, as shown in FIG. 5. In this embodiment, the control system 120 utilizes networking between the light fixtures 110a, 110b, 110c through the power lines 122a, 122b, 122c. For example, a signal from the sensor 114 in the light fixture 110a could be used to control the light fixtures 110b, 110c through networking.

In one embodiment, serial RS-485 communications or Power Line Carrier (PLC) technology could be utilized between the control system 120 and the light fixtures 110a, 110b, 110c. Alternatively, the sensor 114 could be in communication with one or more light fixtures 110a, 110b, 110c through a wired network or a wireless network. Any suitable device could be utilized which allows networking and communication of the light fixtures 110a, 110b, 110c with the control system 120.

In one embodiment, the lighting system 48, 148 could include any type of luminaires, such as a dry luminaire located outside of the pool or spa, or a luminaire that is sporadically both wet and dry. Sensors 14, 114 could be installed in each of these luminaires.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure. What is desired to be protected by Letters Patent is set forth in the appended claims.

What is claimed is:

1. A lighting fixture for use in connection with a pool or spa, comprising:
a light source;
a detection device for detecting the presence of a bather within a pool or a spa, said detection device transmitting a signal into the pool or the spa, and receiving a reflected signal from a bather in the pool or the spa to detect the presence of the bather; and
a microprocessor in electrical communication with said detection device and said light source, said microprocessor adjusting an output of said light source when the bather is detected, so that sufficient light output is generated by the lighting fixture.

2. The lighting fixture of claim 1, wherein said microprocessor adjusts a color of a light emitted from said light source when the bather is detected.

3. The lighting fixture of claim 2, wherein said microprocessor adjusts the color of the light emitted from said light source such that said light source transmits a white color when the bather is detected.

4. The lighting fixture of claim 3, wherein said light source comprises a plurality of light-emitting diodes.

5. The lighting fixture of claim 3, wherein said light source comprises a non-LED light.

6. The lighting fixture of claim 4, wherein said detection device includes a passive sonar detector.

7. The lighting fixture of claim 1, wherein said microprocessor increases the output of the light to a predetermined threshold when the bather is detected.

8. A lighting system for use in connection with a pool or spa, comprising:
a lighting fixture including a light source;
a microprocessor for controlling said light source; and
means for detecting the presence of a bather within a pool or a spa, said microprocessor changing output of said light source so that sufficient light output is generated when the bather is detected.

9. The lighting system of claim 8, wherein the means for detecting comprises at least one sensor.

10. The lighting system of claim 9, wherein said light source comprises a plurality of light-emitting diodes.

11. The lighting system of claim 10, wherein said at least one sensor is installed in said lighting fixture.

12. The lighting system of claim 10, wherein said at least one sensor is located remotely from said lighting fixture.

13. The lighting system of claim 10, wherein at least one sensor is installed external to a pool or a spa.

14. The lighting system of claim 10, further comprising a plurality of sensors, each of said sensors in wireless communication with said lighting fixture.

15. The lighting system of claim 14, further comprising a plurality of lighting fixtures, each of said sensors in communication with one or more of said plurality of lighting fixtures.

16. The lighting system of claim 15, wherein said microprocessor increases the output of the light to a predetermined threshold when the bather is detected.

17. A method for controlling a lighting fixture in a pool or spa, comprising:
illuminating a pool or a spa with a lighting fixture;
detecting the presence of a bather in the pool or the spa; and
changing output of the lighting fixture so that sufficient light output is generated when the bather is detected.

18. The method of claim 17, wherein said lighting fixture includes a plurality of light-emitting diodes.

19. The method of claim 18, wherein the step of detecting the presence of a bather comprises detecting the presence of a bather using infrared energy.

20. The lighting system of claim 8, further comprising a second lighting fixture in communication with the lighting fixture, the lighting fixture controlling output of the second lighting fixture when the lighting fixture detects the bather.
